(19) United States
(12) Patent Application Publication
(10) Pub. No.: US 2018/0304201 A1
(43) Pub. Date: Oct. 25, 2018

(54) ASSEMBLED FILTERS FOR THE FILTRATION OF LIQUIDS

(71) Applicant: SAINT-GOBAIN CENTRE DE RECHERCHES ET D'ETUDES EUROPEEN, Courbevoie (FR)

(72) Inventors: Daniel ECKARDT, Coburg (DE); Michael FABER, Neustadt B. Coburg (DE); Malte MOELLER, Roedental (DE); Ronald NEUFERT, Michelau (DE); Stephan REMPEL, Neustadt B. Coburg (DE); Fabiano RODRIGUES, Roussillon (FR); Adrien VINCENT, Cabannes (FR)

(21) Appl. No.: 15/570,112

(22) PCT Filed: Apr. 29, 2016
(86) PCT No.: PCT/FR2016/051021

§ 371 Date: Oct. 27, 2017

(30) Foreign Application Priority Data
Apr. 29, 2015 (FR) 1553899

(51) Int. Cl. B01D 63/06; B01D 61/02; B01D 61/14

(52) U.S. Cl. CPC B01D 63/066; B01D 63/061; B01D 63/063; B01D 61/027; B01D 2315/12; B01D 61/147; B01D 2313/04; B01D 2315/10; B01D 2319/04; B01D 61/145

(57) ABSTRACT

A membrane filter includes a plurality of honeycomb ceramic filtering elements, each element including a plurality of parallel ducts separated by walls and open on a face for introduction of the liquid to be filtered, an interstitial volume between the filtering elements, a filtration membrane positioned on the inner surface of the walls of the ducts, wherein the filtering elements are joined together by a curable material that forms after curing a sleeve in the form of a single part joining together, by sealing, all of the filtering elements separated the interstitial volume, the sleeve having a thickness e between 1% and 10% of the length of the filter, and the curable material being present in the open porosity and through the entire thickness of each porous wall forming the elements, over a minimum non-zero height h.

The invention relates to the field of filtering structures made of an inorganic material which are intended for the filtration of liquids, in particular structures coated with a membrane in order to separate particles or molecules from a liquid, more particularly water, for example produced water derived from oil or shale gas extraction.

Filters which use ceramic or nonceramic membranes to carry out the filtration of various fluids, in particular polluted water, have been known for a long time. These filters can operate according to the principle of frontal filtration, this technique involving the passage of the fluid to be treated through a filtering media perpendicularly to its surface. This technique is limited by the accumulation of particles and the formation of a cake at the surface of the filtering media, and therefore gives rise to a rapid drop in performance and also a drop in the level of filtration.

According to another technique to which the present invention also relates, use is made of tangential filtration which, in contrast, makes it possible to limit the accumulation of particles by virtue of the longitudinal circulation of the fluid at the surface of the membrane. The particles remain in the circulating stream, while the liquid can pass through the membrane under the effect of the pressure. This technique provides stability of the performance and of the level of filtration. It is more particularly recommended for the filtration of fluids highly laden with particles and/or with molecules.

The strong points of tangential filtration are thus its ease of use, its reliability, by virtue of the use of organic and/or inorganic membranes having a porosity suitable for carrying out said filtration, and its continuous operation.

Tangential filtration requires little or no adjuvant and provides two separate fluids which may both be of economic value: the concentrate (also known as retentate) and the filtrate (also known as permeate); it is a clean process which is environmentally friendly.

According to one alternative in particular useful for the purification of liquids laden with solid particles, the pollutants may remain trapped in the structure. In such a case, no concentrate is recovered at the outlet of the structure, only a filtrate.

Tangential filtration techniques are in particular used for microfiltration, ultrafiltration and nanofiltration.

Many structures of filters that operate according to the principles of tangential filtration are thus known from the current art. They comprise or are constituted from tubular supports made of a porous inorganic material that are formed of walls that delimit longitudinal ducts or channels parallel to the axis of said supports. The liquid to be filtered passes through the walls then the filtrate is discharged, usually at the peripheral outer surface of the porous support.

According to one configuration that is also used, the filters comprise at least one filtering element formed by a plurality of ducts separated by porous walls. Such a structure is commonly referred to in the field as a honeycomb.

The surface of said ducts is also customarily covered with a membrane, usually made of a porous inorganic material, referred to as a membrane or membrane separation layer in the present description, the nature and the morphology of which are suitable for stopping the molecules or the particles having a size that is close to or greater than the median pore diameter of said membrane when the fluid filtered spills into the porosity of the porous support.

In particular, in such filters, the median pore diameter of the material constituting the filtering membrane is normally much smaller than that of the material constituting the walls of the ducts, the ratio generally ranging from 1/1000 to 1/10. In addition, the thickness of the membranes is much thinner than that of the walls, the ratio ranging from 1/200 to ⅕.

The membrane is conventionally deposited on the inner surface of the channels by a process for coating a slurry of the porous inorganic material followed by a consolidating heat treatment, especially a drying and optionally a sintering of the ceramic membranes.

Patent application US 2013/0153485 describes a membrane filter comprising an assembly of filtration elements, the ends of which are connected by a material forming a mounting ring. However, no indication is provided in this application as regards the use of such an embodiment, in particular regarding the means to be used and the conditions that make it possible to obtain a filter that is reliable over time, i.e. having an integrity and leaktightness that are guaranteed and preserved over a prolonged service life of the filter.

In particular, no indication is provided in this publication as regards the mechanical strength conferred on the assembly by the mounting ring, in particular regarding its compression strength and resistance to deformation under the pressure exerted by the housing into which the filtering structure will be inserted during the use thereof, or regarding the filtration performance of a complex filter thus assembled.

It has been proven by the applicant company that the essential problem in such a structure lies in particular in the quality of the filtration of the incoming liquid. Specifically, the applicant company has been able to demonstrate that this quality is strongly dependent on the absence of so-called by-pass zones of the membrane, through which the liquid to be filtered may travel into the structure without having to pass through the active part where the filtration is carried out. In the presence of such zones, the liquid may pass through the filter, without coming into contact with the membrane separation layer of smaller porosity and present at the surface of the porous walls of larger porosity.

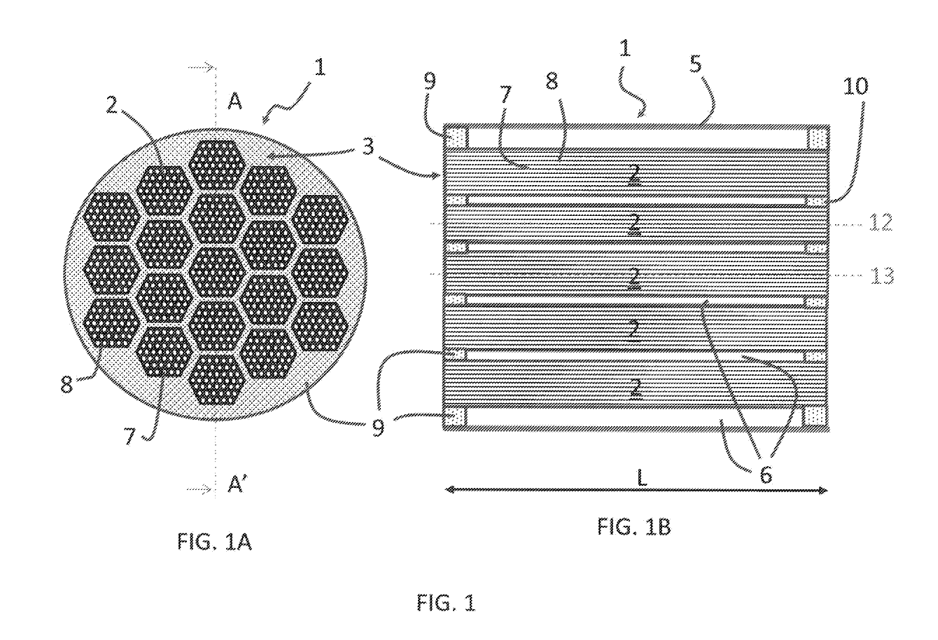

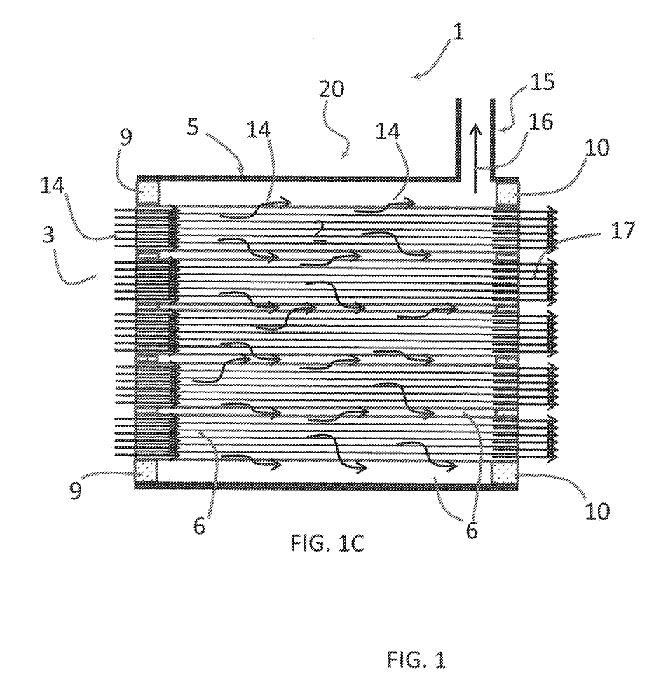

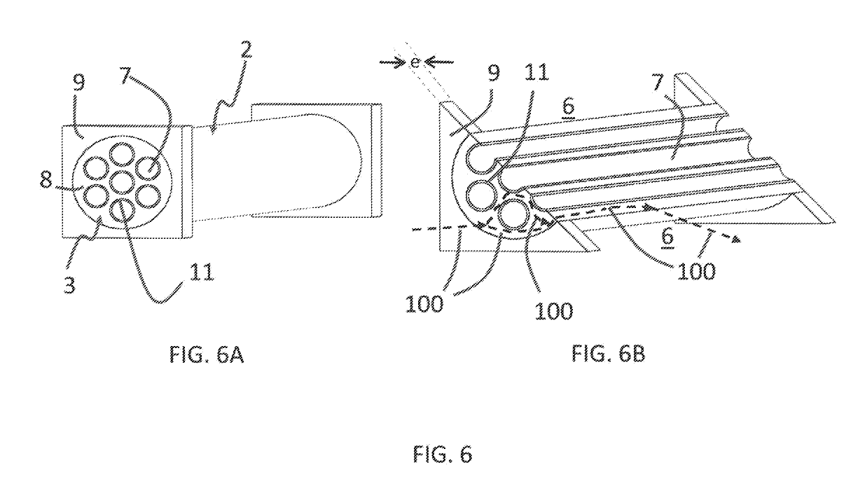

In particular, the tests carried out and reported hereinbelow by the applicant company have demonstrated that a large portion of the liquid in such a structure was able to pass directly into the channels of the structure via the porosity of the support, starting from the end of the filter open on the face for introduction of the liquid to be filtered, without therefore having to pass through the membrane covering the inner walls of the honeycomb ceramic elements. Such a by-pass zone of the membrane is for example illustrated by the arrows 100 in the appended FIG. 6B. Such a problem is even more critical since the filter is not unitary but comprises a plurality of filtering elements as illustrated by FIGS. 1, 5, 7 and 8.

As indicated above, without this however being a certainty, such a phenomena could be explained on account of the large differences in porosity, in pore size and in thickness between the materials respectively constituting the membrane and the walls.

The object of the present invention is to resolve the problems disclosed above, and it proposes in particular to provide a mechanically strong filter, assembled from a set of honeycomb ceramic filtering elements, each comprising a plurality of ducts, and the filtration efficiency of which is optimal, in particular by preventing the presence of by-pass zones in the assembled filter, through which a portion of the liquid is not filtered, while preserving as far as possible the filtration surface area available to the liquid within said filter.

In its most general form, the present invention thus relates to a membrane filter for liquid filtration comprising:
a plurality of honeycomb ceramic filtering elements, preferably positioned substantially parallel in said filter, each element comprising a plurality of parallel ducts separated by walls made of a porous ceramic material, in particular the open porosity of which is between 15% and 60%, said ducts being open on a face for introduction of the liquid to be filtered,
an interstitial volume between said filtering elements,
a filtration membrane formed from a ceramic material positioned on the inner surface of the walls of the ducts,
optionally filtrate recovery means, positioned at the outlet of the ducts and/or at the periphery of the filter. According to the filter according to the invention:
said filtering elements are joined together, at least at the end of the filter that is open on said introduction face, by means of a curable material, in particular a curable resin optionally incorporating a mineral filler, that forms after curing a sleeve in the form of a single part joining together, by sealing, all of said filtering elements, said sleeve maintaining said interstitial volume between said elements,
said sleeve has a thickness e, measured along the longitudinal axis of the filter, between 1% and 10%, preferably between 1.5% and 7% and very preferably between 2% and 5% of the length of the filter, and
the curable material is present in the open porosity and through the entire thickness of each porous wall forming the elements, over a minimum non-zero height h, said height being measured parallel to the longitudinal axis of the element considered and starting from its end that is open on the introduction face.

According to certain preferred embodiments of a filter according to the invention which may of course be combined together where appropriate:
Said minimum height h is less than 2.5×e, preferably is less than 2×e, more preferably is less than 1.5×e and very preferably is less than or equal to 1×e.
The maximum height according to which the curable material is present in the open porosity and through the entire thickness of the porous walls forming the elements is less than 3×e, preferably less than 2.5×e and very preferably less than 2×e.
The filter additionally comprises at least one second sleeve, preferably identical to the first sleeve.
Said second sleeve is positioned at the opposite end of the filter.
The average thickness e of the sleeve is between 2% and 5% of the average length of said elements.
The median diameter of the pores in the porous walls is between 5 and 50 micrometers, preferably between 10 and 40 micrometers.
The median diameter of the pores of the membrane is between 50 nanometers and 10 micrometers and is at least five times smaller than the median diameter of the pores of the porous walls.
The length of the filter is between 200 and 1500 mm.
The thickness of the porous walls of the ducts is between 0.3 and 1.5 mm.
The average thickness of the membrane is between 20 nanometers and 50 micrometers, in particular between 20 nanometers and 10 micrometers, preferably is between 100 nanometers and 2 micrometers.
Preferentially, the average thickness of the membrane is at least 5 times or even at least 10 times its median pore diameter.
The ducts are of square, round or oblong cross section, preferably round cross section, and more preferably the hydraulic diameter of which is between 1 and 5 mm.
The elements are of round cross section, the diameter of said round cross section being between 20 and 80 mm.
The elements are of hexagonal cross section, the distance between two opposite sides of the hexagonal cross section being between 20 and 80 mm.
The ducts of the filtering elements are open on their two ends.
The ducts of the filtering elements are alternately blocked on the face for introduction of the liquid to be filtered and on the opposite face.
The ducts of the filtering elements are open on the liquid introduction face and closed on the recovery face.
The filtrate recovery means are positioned at the periphery of the filter.
The filtering elements and preferably the membrane comprise and preferably essentially consist of particles of silicon nitride and/or of silicon carbide.
The curable material is selected from epoxy resins and acrylate resins.
The curable material comprises a filler consisting of mineral particles, the median diameter D₅₀ of which is between 1 and 100 micrometers.
Said filter is surrounded by a compartment wherein an opening is made that enables said recovery of the filtrate.

In particular, in operation, the filter according to the invention is normally positioned in a compartment (also referred to as housing in the present description). According to this conventional configuration, said compartment therefore surrounds the filtering elements and the sleeve(s). Such a compartment enables in particular the containment of the liquids (filtrate and/or retentate) within a filtration unit.

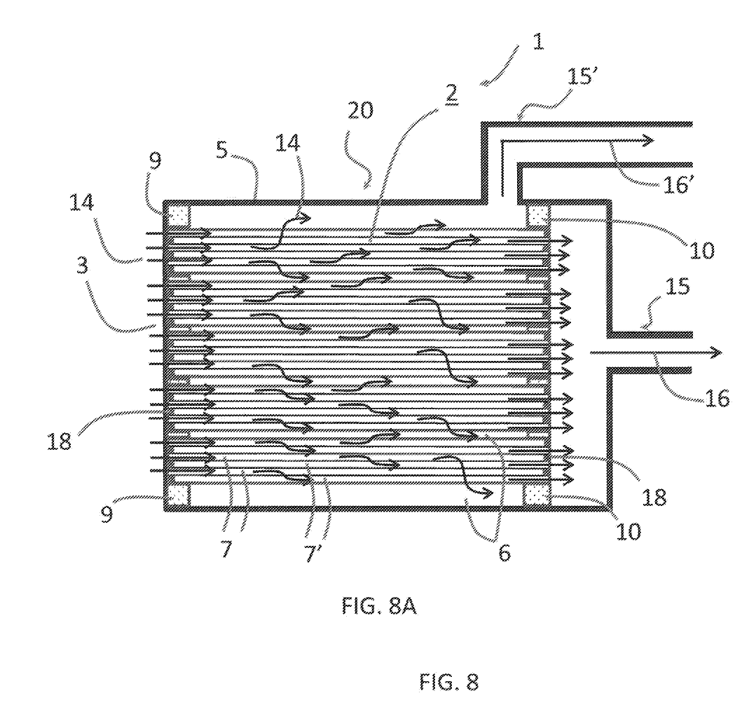

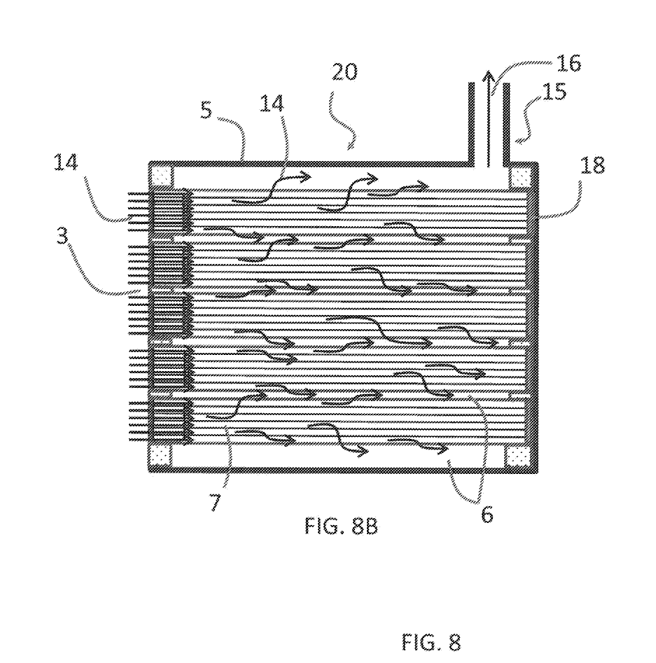

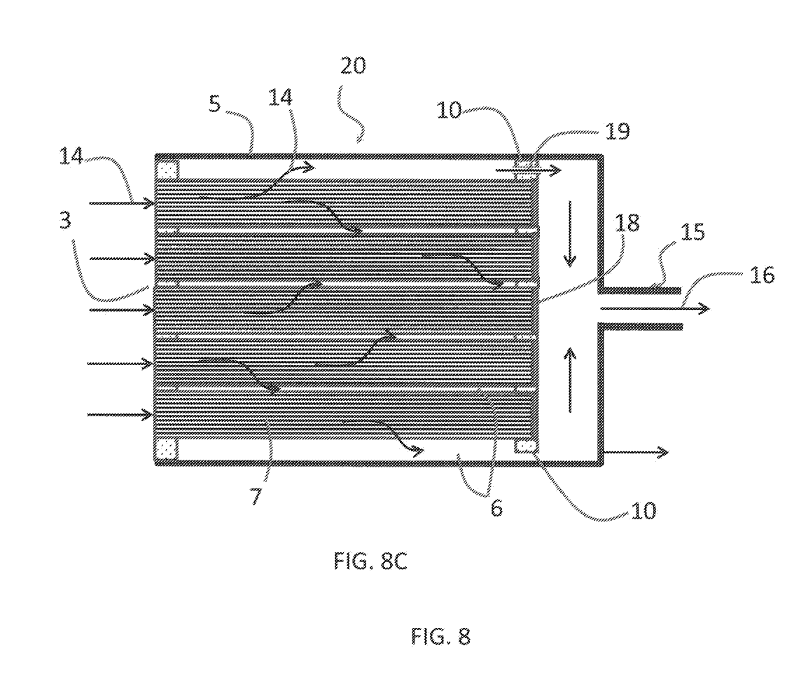

According to one preferred embodiment according to the invention, in particular according to which the filtrate is recovered at the periphery or at the outlet of the filter, said filtrate recovery means may therefore include the compartment (housing) into which said filter is inserted. According to such an embodiment, said means comprise in particular an opening in said compartment, as is described for example in publication US 2013/0153485) or in the appended figures of FIG. 8.

Thus, according to one preferred embodiment of the invention, said recovery means may comprise or else consist of an opening made in the housing surrounding the filter.

The invention also relates to a filtration unit comprising a filter as described above inserted into its compartment, including the filtrate recovery means.

The invention also relates to a process for manufacturing a membrane filter as claimed in one of the preceding claims, comprising the following successive steps:
a. manufacturing a set of honeycomb filtering elements comprising a plurality of parallel ducts separated by walls made of a porous ceramic material, the open porosity of which is between 15% and 60%,
b. depositing, on the inner surface of the porous walls, a filtration membrane formed from a ceramic material,
c. aligning the ends of the filtering elements, according to an arrangement that is substantially parallel along their length, said elements arranged in parallel additionally being held spaced apart so that an interstitial volume is present between each filtering element,
d. preparing a curable material, preferably a resin optionally comprising a filler of mineral particles, and adjusting its viscosity in such a way that said curable material penetrates the entire thickness of each porous wall of all the elements over a non-zero height h, said height being measured along the longitudinal axis of the filter,
e. applying said curable material, starting from at least one end of the filtering elements, to said interstitial volume, over a thickness between 1% and 10% of the length of the elements,
f. curing the curable material to give a sleeve in the form of a single part joining together, by sealing, all of said tubular elements, separated from one another by said interstitial volume.

According to one particular embodiment of the manufacturing process described above, before step c, the ends of each of the filtering elements are preimpregnated with a resin, for example a curable resin that plugs the porosity of the porous ceramic material on the face for introduction of the liquid to be filtered.

Within the meaning of the present description, the following definitions are given:

A channel or duct is understood to mean the space delimited by the porous walls of the structure in which the liquid to be filtered is introduced and flows. Inner channels or ducts are understood for the purposes of the invention to mean the ducts that do not share a common wall with the outer or peripheral surface of the filtering element. In a complementary manner, a duct that has at least one common wall with the outer surface of the filtering element is referred to as peripheral. This wall is referred to as an outer wall. The other walls are referred to as inner walls.

The open porosity and the median diameter of the pores of the porous walls described in the present description are determined in a known manner by mercury porosimetry.

The pore volume is measured by mercury intrusion at 2000 bar using a Micromeritics AutoPore IV 9500 Series mercury porosimeter, on a 1 cm³ sample taken from a block of the product, the sampling region excluding the skin typically extending up to 500 microns from the surface of the block. The applicable standard is ISO 15901-1.2005 part 1. The increase in pressure up to high pressure results in “pushing” the mercury into pores of increasingly small size. The intrusion of mercury is conventionally carried out in two steps. In a first step, mercury intrusion is carried out at low pressure up to 44 psia (around 3 bar), using air pressure to introduce the mercury into the largest pores (>4 μm). In a second step, high-pressure intrusion is carried out with oil up to the maximum pressure of 30 000 psia (around 2000 bar).

In accordance with Washburn's law mentioned in the ISO 15901-1.2005 part 1 standard, a mercury porosimeter thus makes it possible to establish a size distribution of the pores by volume. The median pore diameter of the porous walls corresponds to a threshold of 50% of the population by volume.

The porosity of the membrane, corresponding to the total volume of the pores in the membrane, and the median pore diameter of the membrane are advantageously determined according to the invention with the aid of a scanning electron microscope. Typically, sections of a wall of the support in transverse cross section are produced, so as to visualize the entire thickness of the coating over a cumulative length of at least 1.5 cm. The images are acquired from a sample of at least 50 grains, preferably of at least 100 grains. The area and the equivalent diameter of each of the pores are obtained from photographs by conventional image analysis techniques, optionally after a binarization of the image that aims to increase the contrast thereof. A distribution of equivalent diameters is thus deduced, from which the median pore diameter is extracted.

The porosity of the membrane is obtained by integration of the curve of distribution of equivalent pore diameters.

Likewise, a median size of the particles constituting the membrane layer can be determined by this method.

The median size of the particles constituting the membrane layer is in general between 20 nanometers and 10 micrometers, preferably between 100 nanometers and 2 micrometers.

An example of determination of the median pore diameter or of the median size of the particles constituting the membrane layer, by way of illustration, comprises the following sequence of steps, which is conventional in the field:

A series of SEM photographs is taken of the support with its membrane layer observed along a transverse cross section (that is to say, over the whole thickness of a wall). For greater clarity, the photographs are taken on a polished section of the material. The image is acquired over a cumulative length of the membrane layer at least equal to 1.5 cm, in order to obtain values representative of the whole of the sample.

The photographs are preferably subjected to binarization techniques, well known in image processing techniques, in order to increase the contrast of the outline of the particles or pores.

A measurement of the area is carried out for each particle or each pore constituting the membrane layer. An equivalent pore or grain diameter is determined, corresponding to the diameter of a perfect disk of the same area as that measured for said particle or for said pore (it being possible for this operation to be optionally carried out using dedicated software, in particular Visilog® software sold by Noesis). A distribution of particle or grain size or of pore diameter is thus obtained according to a conventional distribution curve and a median size of the particles and/or a median diameter of pores constituting the membrane layer are thus determined, this median size or this median diameter respectively corresponding to the equivalent diameter dividing said distribution into a first population comprising only particles or pores with an equivalent diameter greater than or equal to this median size and a second population comprising only particles with an equivalent diameter less than this median size or this median diameter.

The median diameter D50 of the powders of the particles, in particular of the silicon carbide SiC powders, used to produce the support or the membrane is evaluated conventionally by a particle size distribution characterization carried out with a laser particle size analyzer in accordance with the ISO 13320-1 standard. The laser particle size analyzer may be, for example, a Partica LA-950 from the company HORIBA. Within the meaning of the present description and unless otherwise mentioned, the median diameter of the particles respectively denotes the diameter of the particles below which 50% by weight of the population is found.

Within the meaning of the present invention, within a filtering element, all the ducts have a cross section and a distribution that are substantially constant and identical over the entire length of the filter, irrespective of the transverse sectional plane considered.

The thickness e of the sleeve is understood to mean the average thickness of said sleeve measured parallel to the longitudinal central axis of the filter. Without departing from the scope of the invention, the thickness of the sleeve may however vary locally substantially in the longitudinal direction of the filter, in particular as a function of the technique for producing the sleeve, for example as a function of the profile of the mold used for casting the curable material binding the filtering elements together.

An example is given below for producing a filtering element that is incorporated in the structure of a filter according to the invention, which of course does not limit the processes for obtaining such an element:

According to a first step, the filtering element is obtained by extruding a paste through a die configured according to the geometry of the structure to be produced according to the invention. The extrusion is followed by a drying and a firing in order to sinter the inorganic material constituting the support and to obtain the porosity and mechanical strength characteristics necessary for the application.

For example, when it is a question of an SiC support, it may in particular be obtained according to the following manufacturing steps:
mixing a mixture comprising silicon carbide particles with a purity of greater than 98% of SiC and having a particle size such that 75% by weight of the particles has a diameter of greater than 30 micrometers, the median diameter by weight of this particle size fraction (measured by laser particle size analysis) being less than 300 micrometers. The mixture also comprises an organic binder of the of the cellulose derivative type. Water is added and mixing is carried out until a homogeneous paste is obtained, the plasticity of which allows extrusion, the die being configured in order to obtain monoliths according to the invention;
microwave drying of the green monoliths for a time sufficient to bring the content of water that is not chemically bound to less than 1% by weight;
firing up to a temperature of at least 1300° C. in the case of a filtering support based on liquid-phase sintered SiC, silicon nitride, silicon oxynitride, silicon aluminum oxynitride or even BN and of at least 1900° C. and below 2400° C. in the case of a filtering support based on recrystallized or solid-phase sintered SiC. In the case of a nitride or oxynitride filtering support, the firing atmosphere is preferably a nitrogen-containing atmosphere. In the case of a recrystallized SiC filtering support, the firing atmosphere is preferably inert and more particularly argon. The temperature is typically maintained for at least 1 hour and preferably for at least 3 hours. The material obtained has an open porosity of from 15% to 60% by volume and a median pore diameter of the order of from 5 to 50 micrometers, preferably between 10 and 40 micrometers.

For example, the average thickness of the outer walls of an element according to the invention is between 0.5 and 2.0 mm. Such a thickness makes it possible in particular to ensure a cohesion and a suitable adhesion between the porous ceramic material constituting the outer wall and the curable resin that is incorporated into its porosity. If necessary, the outer surface of the porous walls may also be made rough to further facilitate the adhesion and the penetration of the resin into the porosity of the walls. The average thickness of the inner walls of the elements is generally thinner than that of the outer walls and is preferably between 0.3 and 1.5 mm.

The length of the filtering elements is in principle between 200 and 1500 mm.

The hydraulic diameter of the ducts (also sometimes referred to as channels in the present description) is preferably between 1 and 5 mm, preferably between 1.5 and 4 mm.

Depending on the type of filtration envisaged (tangential or frontal) and/or the configuration envisaged for the recovery of the filtrate (at the outlet of the channels and/or at the periphery of the filter), certain ducts may or may not be blocked at the ends, in particular at the opposite end of the ducts with reference to the introduction of the liquid into the filter. Preferably, in the case of tangential filtration, no duct is blocked.

The filtering element is then coated according to the invention with a membrane (or membrane separation layer). One or more layers, referred to as primer layers, may be deposited before forming the filtering membrane according to various techniques known to a person skilled in the art: techniques for deposition using suspensions or slips, chemical vapor deposition (CVD) techniques or thermal spraying, for example plasma spraying, techniques.

Preferably, the primer layers and the membrane are deposited by coating using slips or suspensions comprising ceramic particles. A first layer is preferably deposited in contact with the substrate (primer layer), acting as a tie layer. The formulation of the primer comprises 50% by weight of SiC grains (median diameter between 2 and 20 micrometers) and 50% deionized water. A second layer of finer porosity is deposited on the primer layer, and constitutes the actual membrane. The porosity of this latter layer is suitable for giving the filtering element its final properties. The formulation of the membrane preferably comprises 50% by weight of SiC grains (in particular having a median diameter of between 0.1 and 2 micrometers) and 50% deionized water.

In order to control the rheology of these slips and to comply with a suitable viscosity (typically from 0.01 to 1.5 Pa·s, preferably 0.1 to 0.8 Pa·s under a shear gradient of 1 s⁻¹ measured at 22° C. according to the DINC33-53019 standard), thickeners (in proportions typically of between 0.02% and 2% of the weight of water), binders (typically between 0.5% and 20% of the weight of SiC powder), and dispersants (between 0.01% and 1% of the weight of SiC powder) may be added. The thickeners are preferably cellulose derivatives, the binders are preferably PVAs or acrylic derivatives and the dispersants are preferably of ammonium polymethacrylate type.

These coating operations typically make it possible to obtain a primer layer having a thickness of around 30 to 50 micrometers after drying and sintering. During the second coating step, a membrane layer having a thickness of around to 50 micrometers is obtained after drying and sintering.

The element thus coated is then dried at ambient temperature typically for at least 30 minutes then at 60° C. for at least 24 hours. The supports thus dried are sintered at a firing temperature typically between 1700° C. and 2200° C. under a non-oxidizing atmosphere, preferably under argon, so as to obtain a membrane porosity (measured by image analysis as described above) preferably of between 10% and 40% by volume and an equivalent median pore diameter (measured by image analysis) preferably of between 50 nm and 10 micrometers, or even between 100 nm and 5 micrometers.

The lower end of the elements is then leveled off in order to eliminate the excess of the coating materials, which are much more concentrated in this portion of the ceramic part, over a length of around 5 to 20 mm.

The filtration membranes according to the invention preferably have the following features:
They essentially consist of a ceramic material, preferably based on a non-oxide ceramic, preferably selected from silicon carbide SiC, in particular liquid-phase or solid-phase sintered SiC or recrystallized SiC, silicon nitride, in particular Si₃N₄, silicon oxynitride, in particular Si₂ON₂, silicon aluminum oxynitride, boron nitride BN, or a combination thereof. Preferably, the membrane is based on silicon carbide that is typically recrystallized.
They are deposited on one or more layers of a primer having a pore diameter that is intermediate between the (larger) pore diameter of the walls and that of the membrane, in order to facilitate its deposition and its homogeneity. Preferably, the ratio of the mean size of the particles constituting the intermediate layer to that of the particles constituting the membrane layer is between 5 and 50. Preferably, the ratio of the mean size of the grains constituting the porous wall to that of the particles constituting the membrane intermediate layer is between 2 and 20.
Preferably the porosity of the membrane separation layer is less than 70% and very preferably is between 10% and 70%.
The equivalent median pore diameter, measured by image analysis, of the layer forming the membrane is between 1 nm and 5 micrometers.

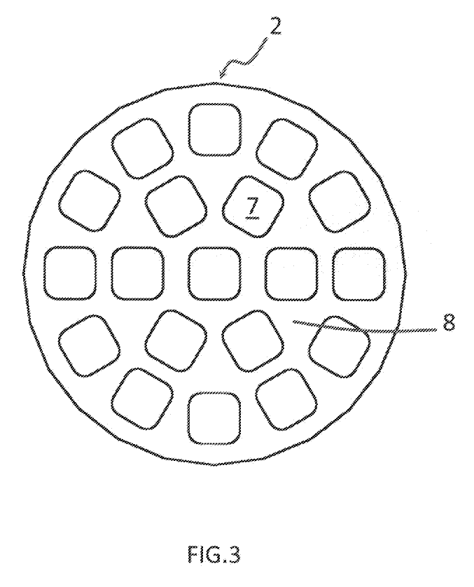

A plurality of the filtering elements thus obtained are then assembled in order to form the filter according to the invention, so as to leave an interstitial void between them through which the filtrate introduced on an introduction face of the filter thus obtained will be able to flow. FIG. 3 shows such a configuration in greater detail.

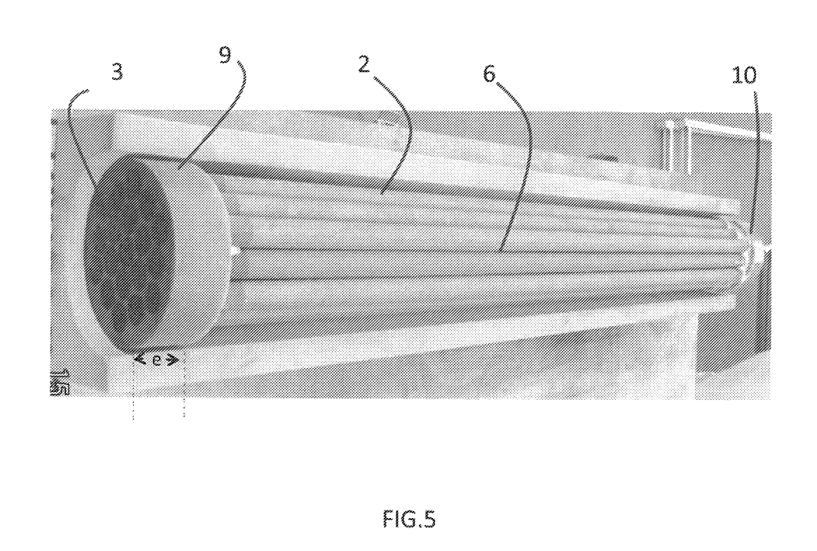

In a more detailed manner, the set of the elements obtained previously are deposited in a container so as to rest on one of their ends. They are also held spaced apart from one another by calibrated spacers. A curable resin, the viscosity of which is suitable according to the invention, is introduced into the container so as to fill the interstices between the elements then the resin is cured, at ambient temperature or under the effect of heating for the case of a thermosetting resin, until a rigid sleeve is obtained in the form of a single part surrounding and joining all of the filtering elements, as illustrated in FIGS. 1 and 5.

Preferably, the same operation is carried out according to a second step at the other end of the filtering elements, in order to obtain the final filter thus comprising a plurality of honeycomb ceramic filtering elements positioned substantially parallel, with an interstitial volume present between said filtering elements.

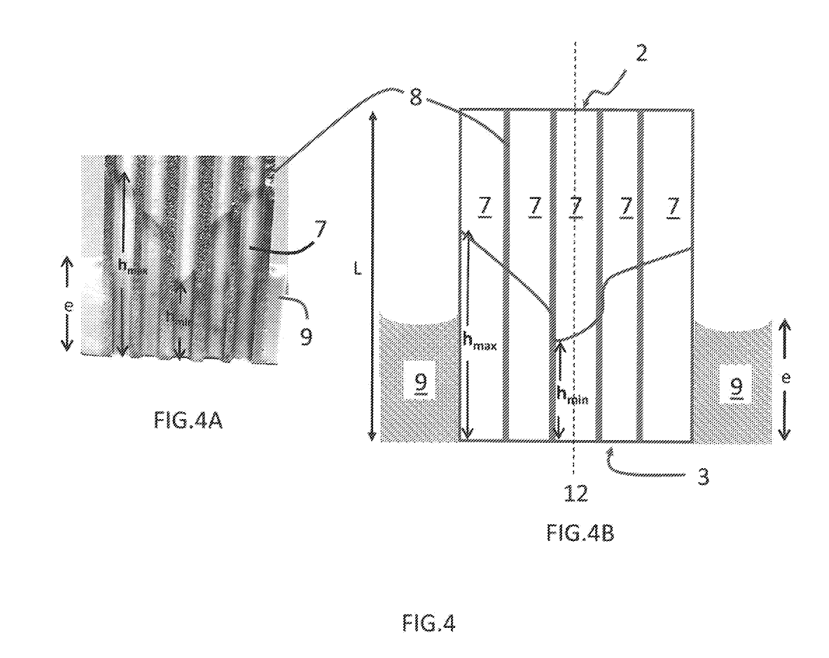

According to the invention, the adjustment of the resin and in particular of its viscosity during this step of forming the sleeve has turned out to be critical for enabling the correct operation of the assembled filter thus obtained, in particular for ensuring the filtration quality of the device. Very particularly, it has been observed, according to the present invention, that the viscosity of the curable resin injected into the container should be low enough for the curable material to penetrate to the core of the open porosity of the walls of the filtering elements, that is to say through the entire thickness of all the porous walls constituting the plurality of elements, in particular through the entire thickness of the inner walls of all the filtering elements used to form the assembled filter. As will be demonstrated by the examples provided in the present description, the presence of the resin throughout the porosity of the walls, over a non-zero height h (cf. FIG. 4), ensures the best operation of the complex structure by effectively preventing the abovementioned by-pass zones (said height being measured along the longitudinal axis of the filter and starting from said end, cf. FIG. 4). According to another essential aspect of the invention, the viscosity should not however be too low either, in order to avoid excessive obstruction of the filtration surface area remaining within the ducts. Experiments carried out by the applicant company have indeed shown that the use of an excessively fluid resin leads, via capillary action, to the blocking of a substantial portion of the porosity of the ducts and consequently a reduction of the filtration capacities of the filter, or even the complete blocking of the most peripheral ducts of the structure. Furthermore, too low a viscosity also leads to a thinner thickness of the final sleeve, prejudicial to the stability and general mechanical strength of the structure.

In the end, the most suitable viscosity was determined to be between 1000 and 3000 mPa·s at 25° C. (or more generally at the temperature at which the curing thereof is carried out), even though its optimal value is capable of varying substantially, in particular as a function of the porosity of the porous walls and/or of the geometry of the ducts. In principle, the assembled filter thus obtained is then inserted into a housing (also referred to as a compartment or casing), comprising inlet openings for the liquid to be filtered and outlet openings for the filtrate and optionally the retentate, according to conventional configurations as for example described in application US 2013/0153485.

The figures associated with the examples that follow are provided in order to illustrate the invention and its advantages, without of course the embodiments thus described being able to be considered to limit the present invention. In the appended figures:

The figures of FIG. 1 (FIGS. 1A and 1B) illustrate a conventional configuration of a filter comprising 19 unitary filtering elements according to the invention, along a frontal view corresponding to the inlet face for the liquid to be filtered (figure LA) and along a longitudinal cross section (FIG. 1B). FIG. 1C shows the filter from FIG. 1B inserted in its housing, during operation.

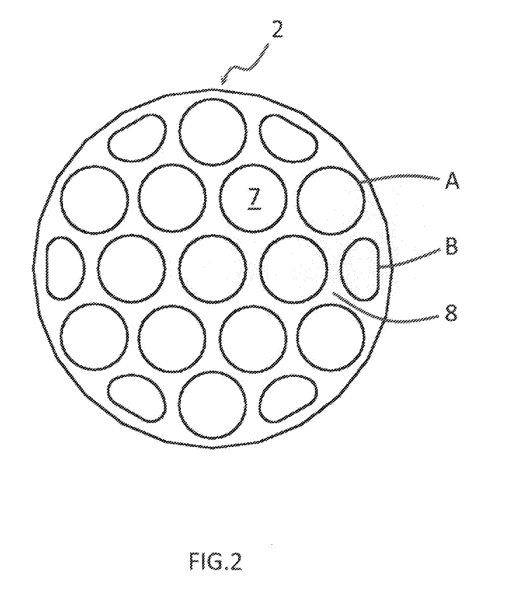

FIG. 2 depicts another configuration of a filtering element according to the invention, before the assembly thereof in a filter according to the invention.

FIG. 3 depicts an alternative configuration of a filtering element according to the invention, before the assembly thereof in a filter according to the invention.

The figures of FIG. 4 (4A and 4B) illustrate the phenomenon of impregnation of the resin in the porosity of the walls of a filtering element during the formation of the sleeve according to the invention. FIG. 4B is a schematic representation, provided for greater clarity, illustrating the characteristics visible in FIG. 4A.

FIG. 5 is a photo of a filter in accordance with the present invention.

The figures of FIG. 6 (6A and 6B) schematically represent a filtering element extracted from the assembly with its portion of the sleeve, along an elevation view (FIG. 6A) and along a three-dimensional cross section (FIG. 6B). FIGS. 6A and 6B are provided in order to illustrate the pathways for possible by-passing of the membrane by the fluid to be filtered in an assembled filter according to the invention.

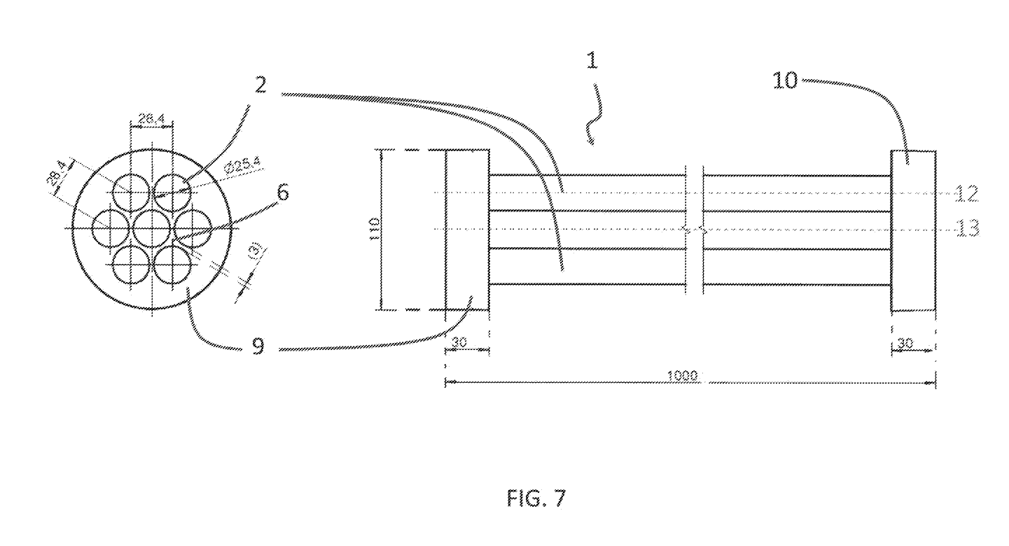

FIG. 7 represents the plane of a filter according to the invention comprising 7 filtering elements. In FIG. 7, the dimensions are indicated are in mm.

The figures of FIG. 8 (8A to 8C) schematically represent, according to other configurations, a filtration unit in accordance with the present invention.

In FIGS. 1 to 8, the same numbers are used to denote the same objects.

FIGS. 1A and 1B illustrate a tangential filter 1 according to the invention, as can be used for the filtration of a liquid. FIG. 1A depicts a frontal view of a filter according to the invention, from the inlet face 3 of the liquid to be filtered. FIG. 1B represents a schematic view of the filter along the longitudinal cross-sectional plane AA′ indicated in FIG. 1A. The filter 1 has a longitudinal central axis 13, perpendicular to the frontal face 3, and passing through its center. The filter comprises a set of filtering elements 2 made of a porous, preferably non-oxide, inorganic material, such as recrystallized SiC. Each element has for example a tubular shape, which may be of hexagonal cross section as illustrated by FIG. 1A or preferably of circular cross section as illustrated by FIG. 2. Each element has a longitudinal central axis 12. The filter is inserted into a housing or compartment, a portion of the walls 5 of which is represented in FIG. 1B. Each element 2 comprises in its internal portion a set of adjacent ducts (or channels) 7, with axes parallel to one another and that are separated from one another by walls 8 formed from the porous material. The walls 8 are therefore formed from a porous inorganic material that lets the filtrate pass from the internal portion of the elements to the outer surface thereof. The ducts 7 are covered over their inner surface with a membrane separation layer (also referred to as filtration membrane or else membrane), coating the inside of the ducts (not represented in the figures of FIG. 1). This filtration membrane comes in contact with said fluid to be filtered flowing in said channels after the introduction thereof into the assembled structure at the inlet face 3. The filtering structure comprises inner ducts and peripheral ducts occupying the ring of outermost channels of the filter. According to one most conventional configuration illustrated by FIG. 1, all the ducts have a cross section of circular shape.

In the configuration according to FIG. 1, the filtering elements have a hexagonal transverse cross section. Of course, the filtering elements may have shapes other than that represented in FIG. 1. In particular, according to one preferred embodiment according to the invention, the filtering elements have a circular cross section, along a cross sectional plane perpendicular to the length thereof. FIG. 2 illustrates such a configuration of the filtering elements. As can be seen in FIG. 2, half of the channels of the peripheral ring have however a truncated shape, in order to retain a sufficient thickness of the outer wall. FIG. 3 illustrates another filter configuration comprising elements having ducts that are arranged in a similar manner to those of FIG. 2, the cross section of the ducts this time being square. According to this configuration, all the ducts have the same cross section.

According to one possible embodiment illustrated by FIGS. 2 and 3, the filter according to the invention comprises a plurality of ducts distributed in several rings around a central axis. A ring of ducts is understood to mean a set of ducts, the barycenter of which is located on one and the same concentric circle of the central axis of the filtering element.

According to the invention, the filtering elements 2 according to FIGS. 1A and 2 and 3 are grouped together in the form of an assembled filter, as illustrated by FIGS. 1B, 5 and 7. Each of the elements 2 is separated from the next by an interstitial volume 6 through which the filtrate resulting from the elements 2 flows, after crossing the membrane. As illustrated by FIGS. 1B, 5 and 7, the filtering elements 2 are held at a distance from one another in order to make an interstitial volume 6 between them, in a single and mechanically strong structure by means of two sleeves 9 and 10 positioned preferably on either side of the elements 2 and at each end thereof. The two sleeves are in contact and are held in compression by the walls 5 of the filtration compartment (often referred to as housing or casing in the field).

In operation, the liquid to be filtered is introduced from the introduction face 3 of the filter thus obtained, passes through the membrane coating the inside of the ducts 7, a filtrate being collected in the interstitial volumes 6 in order to be ultimately collected at the filter outlet, generally through an opening made in the housing surrounding the filter (see for example US 2013/0153485).

By way of example, the embodiment illustrated by FIG. 1C describes the operation of a filter 1 according to the invention as described in FIG. 1B. In FIG. 1C, the arrows 14 indicate the path of the liquid to be filtered in the filtration unit 20. The filter 1 is positioned in its compartment, the walls 5 of which comprise an opening 15 for discharging the filtrate 16. At the outlet of the filter, a retentate 17 is also recovered through the openings of the channels positioned at the opposite end from the introduction face, for optional recycling.

According to other embodiments of the invention illustrated by the figures of FIG. 8 (8A to 8C), only a filtrate 15 is collected. The configurations described in the appended FIGS. 8A to 8C should not however be considered to limit the scope of the present invention, under any of the aspects described.

According to one configuration of a filtration unit incorporating a filter according to the invention, for example illustrated by FIG. 8A, the liquid to be filtered 14 is introduced at the inlet face 3 of the filter. This filter has a structure in which the ducts of the filtering elements 2 are alternately blocked on the face for introduction of the liquid to be filtered and on the opposite face by plugs 18 that are preferably impermeable to the liquids, so as to force the liquid to pass through the porous walls of said filtering elements and the membrane covering them. A distinction is thus made in this embodiment, as illustrated in FIG. 8A, between inlet ducts 7 for the liquid to be filtered and outlet ducts 7′ for the filtrate after having passed through the porous walls provided with a filtration membrane. The filter 1 is contained in the compartment that surrounds it in the filtration unit and one portion of the walls 5 of which is represented in FIG. 8A. The filtrate 16 is recovered at the outlet of the unit 20 through an opening 15 made in the compartment containing the liquids in the filtration unit. Another portion of the filtrate 16′, recovered from the interstitial volumes 6, is collected through an opening 15′ on the peripheral portion of the compartment surrounding the filter.

According to another configuration of a filtration unit incorporating a filter according to the invention, illustrated by FIG. 8B, the liquid to be filtered is introduced at the inlet face 3 of the filter. This filter is contained in the compartment that surrounds it in the filtration unit and one portion of the walls 5 of which is represented in FIG. 8B.

This filter has a structure in which the ducts of the filtering elements 2 are open on the liquid introduction face and closed on the recovery face, by plugs 18, so as to force the liquid to pass through the porous walls of said filtering elements 2 and the membrane covering them.

As illustrated by FIG. 8B, in operation, the liquid to be filtered passes through the porous walls of said filtering elements and the membrane covering them. The filtrate 16 is recovered in the interstitial volumes 6 present around the filtering elements then collected at the outlet of the unit 20 via an opening 15 made in the compartment containing the liquids in the filtration unit. According to one possible embodiment, the ducts 7 are plugged by liquid-tight plugs in order to force all of the filtrate to pass through the interstitial volumes 6. According to another possible embodiment, the sleeve itself ensures the leaktightness of the opposite face of the filter with respect to liquids.

According to an alternative configuration of a filtration unit 20 incorporating a filter according to the invention, illustrated by FIG. 8C, the liquid to be filtered 14 is firstly introduced at the inlet face 3 of the filter. This filter is contained in the compartment that surrounds it in the filtration unit and one portion of the walls 5 of which is represented in FIG. 8C. As illustrated by FIG. 8C, in operation, the liquid to be filtered passes through the porous walls of said filtering elements and the membrane covering them. The filtrate 16 is firstly recovered in the interstitial volume 6 present around the filtering elements. Openings 19 are made in the rear sleeve 10 of the filter to allow the filtrate 16 which is finally collected at the outlet of the unit 20 to be discharged via an opening 15 made in the compartment containing the liquids in the filtration unit. According to one alternative embodiment, as represented in the bottom part of FIG. 8C, a space may be made between compartment 5 and sleeve 10 in order to allow the filtrate 16 to be discharged.

Illustrated in FIGS. 6A and 6B are the difficulties encountered in the implementation of such an assembled filter: when the liquid to be filtered is introduced from the introduction face 3 of the filter, a portion of this liquid passes directly into the largest porosity of the porous walls 8 of the filtering element, without entering into the ducts 7 and passing through the membrane 11. Such a by-pass circuit is illustrated by the arrows 100 in FIG. 6B. The implementation of the present invention makes it possible to solve such a problem.

The following examples make it possible to illustrate the invention and its advantages but in no way limit the scope thereof.

### Examples 1 to 8

Filtering elements, the transverse cross section of which is depicted in FIG. 2, were produced according to the techniques of the art by shaping and firing structures consisting of porous recrystallized silicon carbide, according to the production process described above.

The structural features of the filtering element are listed in table 1 below:

TABLE 1

| Examples | 1-8 |
|---|---|
| FIGURE illustrating the filtering element | 2 |
| Total number of ducts | 19 |
| S_{A} = Total surface area of channel A (mm²) | 16.98 |
| (non-truncated channels) | |
| S_{B} = Total surface area of channel B (mm²) | 9.22 |
| (truncated channels) | |
| Surface area ratio Rs = S_{A}/S_{B} | 1.84 |
| Hydraulic diameter D_{hA} of channel A (mm) | 4.65 |
| Hydraulic diameter D_{hB} of channel B (mm) | 3.26 |
| Ratio Dₕ = D_{hA}/D_{hB} | 1.42 |
| Average thickness of the outer wall (mm) | 0.7 |
| Filtration surface area m²/m of filter length | 0.26 |
| OFA % | 56 |

The hydraulic diameter Dₕ of a channel is calculated, in any transverse sectional plane P of the tubular structure, from the surface area of the cross section of the channel S of said channel and from its perimeter P, along said sectional plane and by applying the following conventional expression:

Dₕ=4×S/P

The OFA (open front area) is obtained by calculating the ratio, as a percentage, of the area covered by the sum of the transverse cross sections of the channels to the total area of the corresponding transverse cross section of the porous support.

The elements according to examples 1 to 6 are obtained according to the same experimental protocol below:

Mixed in a mixer are:
6000 g of a mixture of the two powders of silicon carbide particles with a purity of greater than 98% in the following proportions: 75% by weight of a first powder of particles having a median diameter of the order of 60 micrometers and 25% by weight of a second powder of particles having a median diameter of the order of 2 micrometers. (Within the meaning of the present description, the median diameter d₅₀ denotes the diameter of the particles below which 50% by weight of the population of said particles is found).
600 g of an organic binder of the cellulose derivative type.

Water is added in an amount of around 20% by weight relative to the total weight of SiC and of organic additive and mixing is carried out until a homogeneous paste is obtained, the plasticity of which allows the extrusion of a structure of tubular shape, the die being configured for obtaining monolith blocks, the channels and the outer walls of which have a structure according to the configuration represented in the appended FIG. 2. Thus, green supports having a diameter of 25 mm and a length of 120 cm are synthesized.

The green monoliths thus obtained are dried by microwave radiation for a time sufficient to bring the content of water that is not chemically bound to less than 1% by weight.

The honeycomb monoliths are then fired up to a temperature of at least 2100° C. which is maintained for 5 hours. The material obtained has an open porosity of 43% and a median pore distribution diameter of the order of 25 micrometers, as measured by mercury porosimetry.

A membrane separation layer is then deposited on the inner wall of the channels of the support structure according to the process described below:

A primer for adhesion of the separation layer is formed, in a first step, from a slip, the mineral formulation of which comprises 30% by weight of a powder of grains of black SiC (Sika DPF-C), the median diameter d₅₀ of which is approximately 11 micrometers, 20% by weight of a powder of grains of black SiC (Sika FCP-07), the median diameter d₅₀ of which is approximately 2.5 micrometers, and 50% of deionized water.

A slip of the material constituting the filtration membrane layer is also prepared, the formulation of which comprises 40% by weight of SiC grains (d₅₀ of approximately 0.6 micrometer) and 60% of demineralized water.

The rheology of the slips was adjusted, by addition of the organic additives, to 0.5-0.7 Pa·s under a shear gradient of 1 s⁻¹, measured at 22° C. according to the standard DIN C 33-53019.

These two layers are successively deposited according to the same process described below: the slip is introduced into a tank with stirring (20 rpm). After a phase of deaerating under slight vacuum (typically 25 millibar) while continuing to stir, the tank is overpressurized to approximately 0.7 bar in order to be able to coat the inside of the support from its bottom part up to its upper end.

This operation only takes a few seconds for an element with a length of 120 cm. Immediately after coating the slip over the inner wall of the channels of the support, the excess is discharged by gravity.

Next, the elements are dried at ambient temperature for 30 minutes and then at 60° C. for 30 h. The supports thus dried are then fired at a temperature of 1800° C. under argon for 2 h and at ambient pressure.

The thicknesses of the primer layers and of the membrane filtration layer after sintering are substantially equal and are of the order of 45 micrometers. The firing temperature depends on the characteristics required for the final porosity of the membrane, namely a median pore diameter d₅₀ of around 1 micrometer and a total porosity of 40%, by volume.

Unlike the other examples, the coated supports of examples 7 to 8 were fired at a firing temperature of 1600° C. under nitrogen for 2 h and at ambient pressure. The median pore diameter d₅₀ of the membrane is measured as being equal to around 250 nanometers.

The lower portion of the elements, comprising an accumulation of the materials of the various layers applied, is cut over a length of 10 mm.

A transverse cut is made through the filters thus obtained. The structure of the membrane is observed with a scanning microscope. Observed on an electron microscopy image are the porous wall of the element, of high porosity, the primer layer that enables the adhesion of the membrane separation layer of finer porosity, that ultimately covers the inside of the ducts.

The filtering elements thus synthesized are then dropped into a silicone container so as to rest on one of their ends.

The same initial volume of resin is added for all the examples. Epoxy-based thermosetting resins are introduced into the container so as to make a sleeve between the elements. The viscosity of the resin used is different and is adjusted according to examples 1 to 6 through the chemical nature of the epoxide used, or else through the addition to the initial epoxy resin, before curing, of a mineral filler in the form of a larger or smaller amount of SiC particles of various sizes.

More specifically, two types of resins are used:
an epoxy resin sold by Ebalta under the reference AH110/TG®, with a viscosity of 1950 mPa·s at 25° C.,
an epoxy resin sold by Struers under the reference Epofix™, with a viscosity of 390 mPa·s at 25° C. Two mixtures of different particles are also used to modify the viscosity of the resins:
SiC particles, having a mean diameter d₅₀ of 2 micrometers (sold under the reference FCP 07),
SiC particles, having a mean diameter d₅₀ equal to 45 micrometers (sold under the reference F240).

The smaller the mean diameter of the SiC powder added, the greater the viscosity of the mixture with the resin.

The details of the conditions for preparing the resins for each example are given in table 2 below.

In each case, the curable material is cured at ambient temperature, according to the recommendations and the conditions recommended by the supplier, until a rigid sleeve is obtained that is in the form of a single part surrounding the filtering element, as illustrated schematically in FIG. 1.

After curing the resins, the filtering elements are cut in their center and along the longitudinal direction, that is to say along a longitudinal sectional plane passing through the central axis 12 of the element, and a visual observation of the penetration depth and profile of the resin in each duct is carried out. As indicated in FIG. 4B that schematically illustrates the photograph shown in FIG. 4A, the heights of penetration of the cured material 4 in the porosity of the walls 8 are measured for each of the ducts 7 forming the filtering element.

A minimum height and a maximum height of penetration of the curable material within the walls of the filtering element are thus measured, from the end of the element, as illustrated by FIGS. 4A and 4B. The values are compared to the thickness e finally obtained for the sleeve. The results are reported in table 2 below.

TABLE 2

| | Example | | | | | | | |
|---|---|---|---|---|---|---|---|---|
| | | Example 2 | Example 3 | | | | Example 7 | |
| | Example 1 | (comparative) | (comparative) | Example 4 | Example 5 | Example 6 | (comparative) | Example 8 |
| Element | According to | According to | According to | According to | According to | According to | According to | According to |
| configuration | FIG. 2 | FIG. 2 | FIG. 2 | FIG. 2 | FIG. 2 | FIG. 2 | FIG. 2 | FIG. 2 |
| Median diameter | D50 = | D50 = | D50 = | D50 = | D50 = | D50 = | D50 = | D50 = |
| of the pores in | 1000 nm | 1000 nm | 1000 nm | 1000 nm | 1000 nm | 1000 nm | 250 nm | 250 nm |
| the membrane | | | | | | | | |

Characteristics of the curable material

| | | | | | | | | |
|---|---|---|---|---|---|---|---|---|
| Resin alone | Resin | Resin | Resin | Resin | Resin | Resin | Resin | Resin |
| | AH110TG | AH110TG | Epofix | AH110TG | AH110TG | AH110TG | AH110TG | AH110TG |
| Viscosity of resin | 1950 | 1950 | 390 | 1950 | 1950 | 1950 | 1950 | 1950 |
| alone (mPa · s at | | | | | | | | |
| 25° C.) | | | | | | | | |
| Mineral filler in | no | Yes: FCP 07 | no | Yes: F240 | Yes: F240 | Yes: FCP 07 | Yes: FCP 07 | Yes: F240 |
| the resin | | (D50 = 2 μm) | | (D50 = 45 μm) | (D50 = 45 μm) | (D50 = 2 μm) | (D50 = 2 μm) | (D50 = 45 μm) |
| % mineral filler | NA | 50% | NA | 5% | 50% | 5% | 5% | 5% |
| (weight) | | | | | | | | |

Characteristics after curing of the sleeve

| | | | | | | | | |
|---|---|---|---|---|---|---|---|---|
| Sleeve thickness | 13 | 21 | 7 | 16 | 15 | 17 | 10.5 | 12 |
| (mm) | | | | | | | | |
| hₘₐₓ | 25 | 27 | 24 | 28 | 27 | 27 | 19 | 21 |
| hₘᵢₙ | 13 | 0 | 20 | 13 | 13 | 9 | 0 | 4 |

h/e ratio

| | | | | | | | | |
|---|---|---|---|---|---|---|---|---|
| hₘₐₓ/e | 1.9 | 1.3 | 3.4 | 1.7 | 1.8 | 1.45 | 1.8 | 1.7 |
| hₘᵢₙ/e | 1 | — | 2.8 | 0.8 | 0.9 | 0.3 | — | 0.3 |

The results reported in table 2 above indicate that the adjustment of the viscosity of the initial curable material, before the curing thereof, is critical during this step of forming the sleeve, in order to enable the correct operation of the assembled filter finally obtained, in particular to ensure the filtration quality of the device and the leaktightness thereof.

Firstly, it is observed that the sleeve thicknesses obtained after impregnation and curing are highly variable depending on the nature of the curable material and that the resin always impregnates the peripheral walls over a maximum height greater than the thickness of the final sleeve, due to capillary action.

Moreover, the results show that the use of a resin having an excessively high viscosity (comparative examples 2 and 7) prevents the impregnation of all the walls of the ducts of the element, throughout the thickness thereof and in particular the impregnation of the most central channels of the elements forming the filter.

On the contrary, the use of an excessively fluid resin (comparative example 3) results in the diffusion of the curable material throughout the porosity of the structure and ultimately in a thickness of the sleeve that is significantly reduced relative to the expected thickness. A thin thickness of the sleeve appears to be highly prejudicial to the structural rigidity and to the final integrity of the filter finally assembled from a plurality of elements using the resin of comparative example 3. Moreover, the very high value of the impregnation for all of the ducts of the element (as indicated by the value of 2.8 for the hₘᵢₙ/e parameter according to example 3), also results in a substantial reduction of the filtration surface area accessible to the liquid to be filtered and therefore of the overall filtration capacities of the filter.

Within the meaning of the present invention, the filtration surface area of a filtering element (or of a filter) corresponds to the combined internal surface area of all of the inner walls, covered by the membrane and accessible to the fluid to be filtered in said element (or said filter). In particular, the portion of the walls for which the internal porosity is plugged by the cured material during the manufacture of the sleeve is not considered to be the filtration surface area.

According to examples 4 to 6 and 8 according to the invention, it appears possible to insert a mineral filler into the organic resin in order to increase the mechanical properties thereof, without impairing the quality of the filtration of the incoming liquid and without reducing the filtration surface area. Such a configuration additionally makes it possible to ensure a much better compression strength of the sleeve when the filter thus assembled is inserted into its housing, as explained above.

Example 7 shows that the mixture of curable resin that was suitable for example 6 is no longer suitable in the case of a membrane with significantly smaller pore diameter, the most central ducts of the elements not being impregnated by the curable material, which implies the presence of membrane by-pass zones in the filter.

Example 8 shows that a device with a sleeve thickness and an impregnation of all of the inner walls is possible again, on condition that the filler (and therefore the viscosity) of the mixture in the resin is modified, using particles of significantly larger size.

In summary, the results reported in the preceding table show that the viscosity of the curable material injected into the porosity of the walls of the elements should be adjusted: it should be low enough for the curable material to penetrate into the open porosity and through the entire thickness of all the porous walls forming the plurality of elements, in particular through the entire thickness of the innermost walls of all the filtering elements used to form the assembled filter. As demonstrated by the preceding examples, the presence of the resin throughout the porosity of the walls, over a non-zero height h (said height being measured along the longitudinal axis of the filter and from said end) ensures the best operation of the complex structure by effectively preventing the abovementioned by-pass zones. According to another essential aspect of the invention, the viscosity should not however be too low, in order to avoid the obstruction of an excessively large part of the filtration surface area remaining within the ducts and the general weakening of the assembled filter due to a lack of thickness of the sleeves that join the constituent elements of the structure.

In order to compare the filtration performances for the filters according to the invention, a filtration is carried out using assembled filters having the configuration represented in FIG. 7.

More specifically, a turbidity measurement is carried out on the filters corresponding to assemblies of 7 filtering elements in accordance with the appended FIG. 7, using the filtering elements and the sleeve compositions respectively described in examples 1 and 2 above.

More specifically, two filters are synthesized and assembled, each from 7 filtering elements as described in the preceding examples.

The first filter according to the invention is obtained by joining the 7 filtering elements together, over the two ends by sleeves 9 and 10, by means of the curable material as described in example 1. According to the invention and as illustrated in FIG. 7, the filter is obtained after curing the sleeves in the form of a single part that joins, by sealing, all of the 7 filtering elements.

The second comparative filter is obtained in the same way as the first, but using this time, as curable material, the mixture of the resin and of the filler described in example 2.

The following method is used:

Use is made of synthetic dirty water comprising clay, salt, oil and surfactants at contents respectively equal to 100 ppm, 4000 ppm, 300 ppm and 2 ppm.

The dirty water supplies, at a constant temperature of 25° C., the two filters to be evaluated under a trans-membrane pressure of 0.5 bar and a flow rate in the channels of 3 m/s. The filtrate (purified water) is recovered at the periphery of the filter, via the interstices 6.

In order to estimate the filtration performance of the filter, the turbidity of the filtrate is measured continuously using a LAT N1 series beam turbidity meter supplied by Kobold Instrumentation, by the end of 10 filtration cycles. A lower value after the turbidity test therefore corresponds to a better quality of filtration of the incoming liquid, which may itself be directly linked to the absence of by-pass zones 100 of the filtering membrane, as described in FIG. 6B.

This expressed turbidity is 0.8 NTU for the first filter (according to the invention) and 3.5 for the comparative filter. Such a difference proves the increased filtration efficiency of the filter obtained according to the principles of the present invention.

1. A membrane filter for liquid filtration comprising:
a plurality of honeycomb ceramic filtering elements, each filtering element comprising a plurality of parallel ducts separated by walls made of a porous ceramic material, said ducts being open on an introduction face for introduction of the liquid to be filtered,
an interstitial volume between said filtering elements,
a filtration membrane formed from a ceramic material positioned on an inner surface of the walls of the ducts,
a filtrate recovery system, positioned at an outlet of the ducts and/or at a periphery of the filter,
wherein:
said filtering elements are joined together, at least at the end of the filter that is open on said introduction face, by means of a curable material, that forms after curing a first sleeve in the form of a single part joining together, by sealing, all of said filtering elements,
said first sleeve additionally being configured to maintain said interstitial volume between said filtering elements,
said first sleeve has an average thickness e, measured along a longitudinal axis of the filter, between 1% and 10% of a length of the filter, and
the curable material is present in the open porosity and through an entire thickness of each porous wall forming the filtering elements, over a minimum non-zero height h, said height being measured parallel to the longitudinal axis of the filtering element considered and starting from its end that is open on the introduction face.

2. The membrane filter as claimed in claim 1, wherein said minimum height h is less than 2.5×e.

3. The membrane filter as claimed in claim 1, wherein the maximum height according to which the curable material is present in an open porosity of the porous ceramic material and through the entire thickness of the porous walls forming the elements is less than 3×e.

4. The membrane filter as claimed in claim 1, further comprising at least one second sleeve.

5. The membrane filter as claimed in claim 4, wherein said second sleeve is positioned at the opposite end of the filter.

6. The membrane filter as claimed in claim 1, wherein the average thickness e of the first sleeve is between 2% and 5% of an average length of said elements.

7. The membrane filter as claimed in claim 1, wherein a median diameter of pores in the porous walls is between 5 and 50 micrometers.

8. The membrane filter as claimed in claim 1, wherein a median diameter of pores of the membrane is between 50 nm and 10 micrometers and is at least five times smaller than a median diameter of pores of the porous walls.

9. The membrane filter as claimed in claim 1, wherein the length of the filter is between 200 and 1500 mm.

10. The membrane filter as claimed in claim 1, wherein the thickness of the porous walls of the ducts is between 0.3 and 1.5 mm.

11. The membrane filter as claimed in claim 1, wherein the thickness of the membrane is between 20 nanometers and 50 micrometers.

12. The membrane filter as claimed in claim 1, wherein the ducts are of square, round or oblong cross section and have a hydraulic diameter between 1 and 5 mm.

13. (canceled)

14. (canceled)

15. (canceled)

16. The membrane filter as claimed in claim 1, wherein the ducts of the filtering elements are alternately blocked on the introduction face for introduction of the liquid to be filtered and on an opposite face to the introduction face.

17. The membrane filter as claimed in claim 1, wherein the ducts of the filtering elements are open on the liquid introduction face and closed on a recovery face.

18. (canceled)

19. The membrane filter as claimed in claim 1, wherein the filtering elements comprise particles of silicon nitride and/or of silicon carbide.

20. The membrane filter as claimed in claim 1, wherein the curable material is selected from epoxy resins and acrylate resins.

21. The membrane filter as claimed in claim 1, wherein the curable material comprises a filler consisting of mineral particles, a median diameter D₅₀ of which is between 1 and 100 micrometers.

22. The membrane filter as claimed in claim 1, said filter being surrounded by a compartment wherein an opening is made that enables said recovery of the filtrate.

23. A process for manufacturing a membrane filter as claimed in claim 1, comprising the following successive steps:
a. manufacturing a set of honeycomb filtering elements comprising a plurality of parallel ducts separated by walls made of a porous ceramic material, an open porosity of which is between 15% and 60%,
b. depositing, on the inner surface of the porous walls, a filtration membrane formed from a ceramic material,
c. aligning the ends of the filtering elements, according to an arrangement that is substantially parallel along their length, said elements arranged in parallel additionally being held spaced apart so that an interstitial volume is present between each filtering element,
d. preparing a curable material, and adjusting its viscosity in such a way that said curable material penetrates the entire thickness of each porous wall of all the elements over a non-zero height h, said height being measured along the longitudinal axis of the filter,
e. applying said curable material, starting from at least one end of the filtering elements, to said interstitial volume, over a thickness between 1% and 10% of the length of the elements,
f. curing said curable material to give a sleeve in the form of a single part joining together, by sealing, all of said tubular elements, separated from one another by said interstitial volume.

24. (canceled)

25. The membrane filter as claimed in claim 1, wherein the plurality of honeycomb ceramic filtering elements are positioned substantially parallel in said membrane filter.

26. The membrane filter as claimed in claim 1, wherein an open porosity of the porous ceramic material is between 15% and 60%.

27. The membrane filter as claimed in claim 1, wherein the curable material is a curable resin optionally incorporating a mineral filler.
